(19) United States
(12) Patent Application Publication
(10) Pub. No.: US 2015/0373110 A1
(43) Pub. Date: Dec. 24, 2015

(54) DATA COMMUNICATIONS SYSTEM FOR AN AIRCRAFT

(71) Applicant: GE Aviation Systems LLC, Grand Rapids, MI (US)

(72) Inventors: Eric Daniel Buehler, Grand Rapids, MI (US); Richard John Reiffer, JR., Middleville, MI (US); Ryan David Graffy, Byron Center, MI (US)

(21) Appl. No.: 14/311,465

(22) Filed: Jun. 23, 2014

(51) Int. Cl. H04L 29/08; G06F 17/30

(52) U.S. Cl. CPC H04L 67/1097; G06F 17/302; H04L 67/12

(57) ABSTRACT

A data communications system for an aircraft comprising a plurality of line-replaceable units and a data network configured according to an ARINC standard defining ports, and interconnecting the plurality of line-replaceable units, wherein the line-replaceable units communicate via the ports of the data network.

### BACKGROUND OF THE INVENTION

A line-replaceable unit (LRU) is a modular component of a larger unit, such as a vehicle or aircraft, and is designed to specifications to assure they can be interchanged and/or replaced in the event of failure. LRUs of an aircraft, for example, may include entirely contained systems, sensors, radios, or other auxiliary equipment to manage and/or operate aircraft functions. In the aircraft environment, LRUs may be designed to operate according to a particular operation, interoperability, and/or form factor standards, such as those defined by ARINC series standards.

### BRIEF DESCRIPTION OF THE INVENTION

In one aspect, the invention relates to a data communication system for an aircraft including a plurality of line replaceable units (LRU) having a first processor and a first memory, with a network file system client program stored in the memory and executable by the processor, a data storage unit having a second processor and second memory, with a network file system server program stored in the second memory and executed by the processor, and a data network configured according to an ARINC standard defining service access ports (SAPs), and interconnecting the plurality of LRUs and the data storage unit. The network file system client and the network file system server communicate via the SAPs of the data network.

In another aspect, the invention relates to data communications system for an aircraft including a plurality of line replaceable units (LRU) having a first processor and a first memory, with a network file system client program stored in the memory and executable by the processor, a data storage unit having a second processor and second memory, with a network file system server program stored in the second memory and executed by the processor, and a data network configured according to an ARINC standard defining queuing ports, and interconnecting the plurality of LRUs and the data storage unit. The network file system client and the network file system server communicate via the queuing ports of the data network.

### BRIEF DESCRIPTION OF THE DRAWINGS

In the drawings:

FIG. 1 is a top down schematic view of the aircraft and communications network in accordance with one embodiment of the invention.

FIG. 2 is a schematic view of a data communications network of an aircraft, in accordance with one embodiment of the invention.

FIG. 3 is a schematic view of a data communications network of an aircraft, in accordance with a second embodiment of the invention.

### DESCRIPTION OF EMBODIMENTS OF THE INVENTION

The described embodiments of the present invention are directed toward an aircraft component data network having a network-based mass storage device accessible to a plurality of sensors, systems, and components of the aircraft.

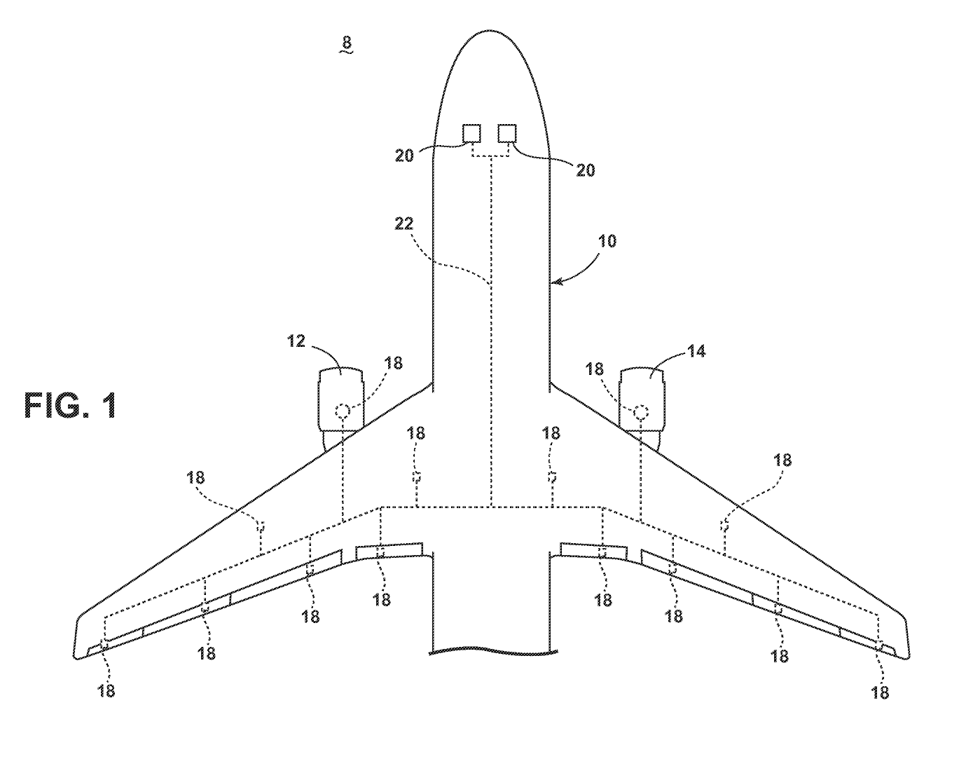

As illustrated in FIG. 1, an aircraft 8 is shown having a fuselage 10 and at least one turbine engine, shown as a left engine system 12 and a right engine system 14. The left and right engine systems 12, 14 may be substantially identical. While turbine engines 12, 14 are illustrated, the aircraft may include fewer or additional engine systems, or alternative propulsion engine systems, such as propeller-based engines. The aircraft 8 is shown further comprising a plurality of sensors, systems, and components, collectively referred to as line-replaceable units (LRUs) 18, and at least one data storage unit 20, shown as two data storage units 20 located proximate to each other, near the nose of the aircraft 8. The LRUs 18 and data storage unit 20 may be communicatively interconnected by transmission and/or communication lines defining a communications network 22, traversing at least a portion of the aircraft 8. Examples of LRUs 18 may include flight management systems and/or onboard maintenance systems. Additional LRUs 18 may be included.

The aircraft 8 shown in FIG. 1 is merely a schematic representation of one embodiment of the invention, and used to illustrate that a plurality of LRUs 18 and data storage units 20 may be located throughout the aircraft 8. The exact location of the LRUs 18 and data storage units 20 are not germane to the embodiments of the invention. Additionally, more or fewer LRUs 18 and/or data storage units 20 may be included in embodiments of the invention.

The communications network 22 is illustrated as a bus, but may include a number of data communication connectors and interfaces, for example, Ethernet or fiber-optic cables, and routing and/or switching components, to facilitate the communicative interconnection between the LRUs and data storage unit 20. Furthermore, the configuration and operation of the communications network 22 may be defined by a common set of standards or regulations applicable to particular aircraft environments. For example, the communications network 22 on an aircraft 8 may be defined by, and/or configured according to, the ARINC 664 (A664) standard, incorporated herein by reference in its entirety. In the exemplary A664 standard, transmissive operations of the data network 22 may include predefined source and/or destination routing tables.

A brief summary of the contemplated environment utilizing the A664 standard should aid in a more complete understanding. A664 defines a serial data transfer method based on conventional Ethernet defined in the standard IEEE 802.3 specification. A664 defines a particular configuration of the behavior of the communications carried by the network through traffic control methods, which guarantee the bandwidth of each logical communications channel, called a virtual link, between two components on the network, by configuring a schedule wherein each channel is guaranteed a scheduled period for transmission. A664 further improves reliability over conventional Ethernet networks by requiring redundant interconnections between components on the network that is, requiring two channels transmitting the same data at the same time, between components. The redundancy is important in the aircraft industry.

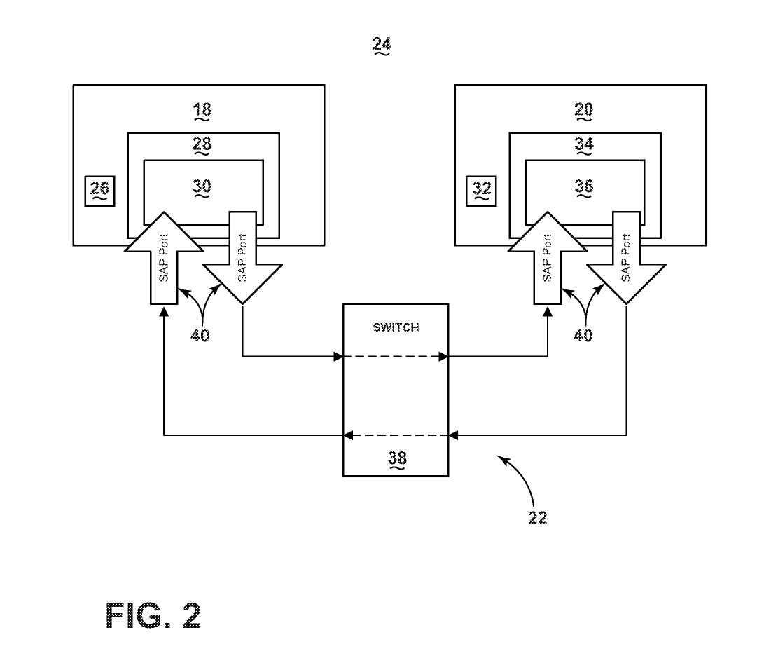

FIG. 2 shows a schematic illustration of a data communications system 24 in accordance with one embodiment of the invention. While the A664 standard requires redundant interconnections between components, only a single data network 22 connection is illustrated for brevity. The data communications system 24 comprises at least one LRU 18 node communicatively coupled with at least one data storage unit 20 node via the communications network 22. The LRU 18 may further include a first processor 26 and a first memory 28, which further includes a network file system client program 30, or set of executable instructions, stored in the first memory 28. Likewise, the data storage unit 20 may further include a second processor 32 and a second memory 34, which further includes a network file system server program 36, or set of executable instructions, stored in the second memory 34.

Each memory 28, 34 may include random access memory (RAM), read-only memory (ROM), flash memory, or one or more different types of portable electronic memory, such as discs, DVDs, CD-ROMs, etc., or any suitable combination of these types of memory, for storing the respective network file system client and server programs. The second memory 34 may also include a significantly larger amount of memory, as compared to the first memory 28, and may comprise, for example, a mass storage device, disk drive, solid state drive. Each processor 26, 32 is operably coupled to their respective memories 28, 34 such that the processor 26, 32 may access and execute the respective network file system client or server programs 30, 36.

The communications network 22 may further include one or more routers or switches 38 (illustrated as a single switch 38) for facilitating the data through the communications network 22 (e.g. through IP address and/or UDP port number routing) between the LRU 18 and the data storage unit 20.

Due to aircraft networks being limited to regulatory standards, such as the A664 standard, and the regulatory standard not including or designed to incorporate additional data network protocols found in “off the shelf” componentry, specialized versions of components, such as LRUs 18, must be developed for aircraft, often at a greater cost. Embodiments of the invention provide for incorporating additional (non-A664-compliant) data network protocols, utilizing the existing A664 standards. As shown, each of the LRU 18 and the data storage unit 20 provide bi-directional network 22 access to the respective units 18, 20, the memories 28, 34, and/or the programs 30, 36 by way of service access ports (SAPs) 40. As defined by the A664 standard, SAPs 40 provide for transfers and communications between communicative nodes by allowing for non-A664-compliant data, instructions, and/or messages to be communicated over an A664 communications network 22.

These non-standard transfers and communications occur when at least one of the sending SAP 40 and/or a sending node operation, such as the network file system client or server program 30, 36, creates, configures, and/or generates an otherwise non-A664-compliant message, and then wraps the non-compliant instruction or message such that it is included in the message payload of a SAP 40 compliant and/or A664-compliant message. The A664-compliant message is transmitted to the communications network 22, where it may be routed by one or more switches 38 based on one or more predefine routing characteristics, to predefined destination node. At least one of the receiving SAP 40 and/or a receiving node operation, such as the network file system client or server program 30, 36, may then decode, unwrap, or strip the A664-compliant message to reveal or recreate the original non-A664-compliant message, which is then delivered for execution and/or operation at the destination node.

By utilizing the SAPs 40 and the A664 data network 22, the LRU 18 and data storage unit 20, as well as the network file system client 30 and the network file system server 36, are capable of communicating with each other via non-A664-compliant protocols, by way of the data communications system 24.

For example, embodiments of the invention may include an LRU 18, data storage unit 20, network file system client program 30, and/or network file system server program 36 configured to operate, or to provide functionality not included in the A664 standard. In one instance, a stateless protocol, such as the network file system protocol, version 3 (NFSv3 protocol) may be utilized to provide communicative access between the first memory 28 and second memory 34, via the data communications system 24. In this sense, the NFSv3 protocol may be used to implement non-A664-native remote access of the second memory 34, by the LRU 18, as if it was located at the LRU 18. Similarly, the NFSv3 protocol may be used to implement non-A664-native remote access of the first memory 28, by the data storage unit 20, as if it was located at the LRU 18.

As used herein, “access” may include a plurality of memory and storage operations implemented by the NFSv3 protocol, or another protocol. Non-limiting examples of “access” may include read access, write access, rename access, create access, delete access, and/or seek access. Furthermore, the NFSv3 protocol, or another protocol, may support non-A664-native secondary functions for providing or limiting “access”, such as supporting authentication access (e.g. source/destination identification or keyed access), supporting storage directory or hierarchy access, wherein different directories may have difference “access” levels or types, and/or supporting “access” to files larger than 2 gigabytes (GB) of data.

Alternative protocols may be included that may provide the aforementioned, or other non-A664-native functionalities. For example, protocols may allow or provide for design constraints such as unique storage directory mounting for one or more LRUs 18, storage size limitations and/or “pruning” of data (that is, methods for removing or reducing the amount of stored data) in the second memory 34 for one or more LRUs 18. In another alternative example, certain protocols may be selected in order to minimize protocol overhead and complexity.

Additionally, protocols may be utilized that provide state-based transactions, wherein only a portion of requested communications take place, for example, where the scheduling of the A664 standard would prevent large files from being transmitted. Alternatively, the predefined scheduling of the A664 standard may be modified to provide longer schedule slots for the SAP 40 communications between the LRU 18 and the data storage unit 20, when necessary.

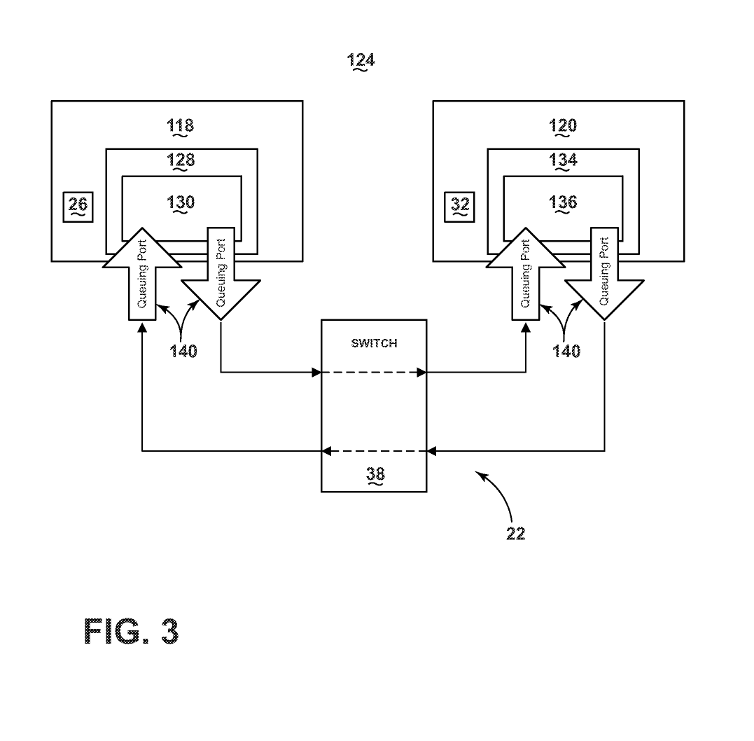

FIG. 3 illustrates an alternative data communications system 124 according to a second embodiment of the invention. The second embodiment is similar to the first embodiment; therefore, like parts will be identified with like numerals increased by 100, with it being understood that the description of the like parts of the first embodiment applies to the second embodiment, unless otherwise noted. A difference between the first embodiment and the second embodiment is that the data communications system 124 of the second embodiment utilizes queuing ports 140 for communicative means, as opposed to the SAPs 40 of the first embodiment. In this sense, embodiments of the invention may include an LRU 118, data storage unit 120, first memory 128, second memory 134, network file system client program 130, and/or network file system server program 136 configured to operate, or to provide functionality not included in the A664 standard, such as providing access, as defined above, via the NFSv3 protocol (or alternative protocol) by way of the queuing ports 140.

Many other possible embodiments and configurations in addition to that shown in the above figures are contemplated by the present disclosure. For example, either of the LRU 18 or data storage unit 20 may include a plurality of software partitions, in addition to a partition including the respective network file system client or server program 30, 36. In this example, each software partition may provide a different functionality, yet be stored in a shared memory 28, 34, and executed by a shared processor 26, 32. Additionally, while a single data storage unit 20 and single second memory 34 are illustrated, embodiments of the invention may include a plurality of data storage units 20 and/or LRUs 18. For example, a plurality of LRUs 18 may each be configured to access a single data storage unit 20. In another example, multiple data storage units 20 may be configured to operate redundantly to share access loads, or may operate independently to access a subset of predefined LRUs 18, or independent networks. In yet another example, multiple LRUs 18 or multiple data storage units 20 may be configured to access a similar unit (e.g. LRU to LRU, data storage unit to data storage unit). Additionally, while a single second memory 34 unit is shown, embodiments of the invention may include mass storage systems, such as arrays of memory, for accessible data storage.

The embodiments disclosed herein provide a data communications system for an aircraft. The technical effect is that the above described embodiments enable non-A664-compliant protocols, such as those allowing network file system storage, on A664-compliant systems. One advantage that may be realized in the above embodiments is that the above described embodiments is that alternative protocols may be utilized that have wide-ranging industry and/or hardware adoption, allowing “off the shelf” components, such as solid state drives, to be incorporated into A664 standards-based systems for centralized or redundant storage without losing A664 certification. “Off the shelf” components typically have reduced costs compared to specialized systems. Another advantage of the above described embodiments is that each LRU may have access to vastly superior amounts of memory, as opposed to what is carried onboard the LRU. This may allow for the retention of detailed flight or aircraft operations data that might have been otherwise overwritten or lost. Furthermore, by allowing files larger than 2 GB, information can be continuously appended for massive amounts of retained data.

Yet another advantage of the above described embodiments is that the A664 standard maps well to the NFSv3 protocol due to the inclusion of IP-based routing and UDP support in each layer. Furthermore, the above described embodiments are configurable and scalable to both large and small systems, by adding or removing additional storage memory.

In yet another advantage, the above described embodiments provide for a stateless protocol in NFSv3, which will improve reliability of the data communications system in the event that a component fails or is reinitialized. The lack of state allows for the system to not be hung up waiting for a state that never appears.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A data communication system for an aircraft comprising:
a plurality of line-replaceable units (LRU) having a first processor and a first memory, with a network file system client program stored in the first memory and executable by the first processor;
a data storage unit having a second processor and second memory, with a network file system server program stored in the second memory and executed by the second processor; and
a data network configured according to an ARINC standard defining service access ports (SAPs), and interconnecting the plurality of LRUs and the data storage unit;
wherein the network file system client and the network file system server communicate via ARINC standard routing of the data network and the network file system communications are transmitted as SAP payloads.

2. The aircraft of claim 1 wherein the network file system client and network file system server operate in accordance with a stateless protocol.

3. The aircraft of claim 1 wherein the network file system client and network file system server operate in accordance with the NFSv3 protocol.

4. The aircraft of claim 1 wherein the network file system client and network file system server operate in accordance with a protocol that provides at least one of read, write, rename, create, delete, or seek access.

5. The aircraft of claim 4 wherein the protocol supports authentication access.

6. The aircraft of claim 4 wherein the protocol supports storage directories.

7. The aircraft of claim 1 wherein the network file system client and network file system server operate in accordance with a protocol that supports access to files larger than 2 gigabytes (GB) of data.

8. The aircraft of claim 1 wherein the ARINC standard is ARINC 664.

9. The aircraft of claim 1 wherein the ARINC standard defines scheduled access between the plurality of LRUs and the data storage unit.

10. The aircraft of claim 1 wherein each LRU further comprises a first memory having at least one partition.

11. The aircraft of claim 10 wherein the at least one partition includes the network file system client.

12. The aircraft of claim 1 wherein the plurality of LRUs and the data storage unit are further configured to provide at least one of read, write, create, delete or seek access to the second memory of the data storage unit.

13. The aircraft of claim 1 wherein each of the network file system client and the network file system server are configured to generate network file system instructions wrapped in an SAP-compatible data payload.

14. The aircraft of claim 1 wherein the communication between the network file system client and the network file system server is configured to provide the network file system client access to the second memory of the data storage unit.

15. A data communications system for an aircraft comprising:
a plurality of line replaceable units (LRU) having a first processor and a first memory, with a network file system client program stored in the first memory and executable by the first processor;
a data storage unit having a second processor and second memory, with a network file system server program stored in the second memory and executed by the second processor; and
a data network configured according to an ARINC standard defining queuing ports, and interconnecting the plurality of LRUs and the data storage unit;
wherein the network file system client and the network file system server communicate via ARINC standard routing of the data network and the network file system communications are transmitted as queuing port payloads.
